(19) United States
(12) Patent Application Publication
(10) Pub. No.: US 2005/0271491 A1
(43) Pub. Date: Dec. 8, 2005

(54) Fastening element, particularly for blind rivets

(75) Inventor: Reinhold Opper, BUSECK (DE)

Correspondence Address: MILES & STOCKBRIDGE PC, 1751 PINNACLE DRIVE, SUITE 500, MCLEAN, VA, 22102-3833, US

(73) Assignee: NEWFREY LLC

(21) Appl. No.: 10/526,458

(22) PCT Filed: Sep. 1, 2003
(86) PCT No.: PCT/EP03/09686

§ 371 Date: Mar. 3, 2005

(30) Foreign Application Priority Data
Sep. 4, 2002 (DE) 102 41 326.6

(51) Int. Cl. F16B 13/04

(52) U.S. Cl. 411/30; 411/34

(57) ABSTRACT

The invention describes a fastening element (1), in particular for blind riveting, having a sethead (4), a deformation segment (2) and a shank end (3), the deformation segment (2) being arranged between the sethead (4) and the shank end (3), and the fastening element (1) being hollow inside, optionally with a mandrel (7) inside the fastening element (1), comprising a mandrel head (23) and a mandrel foot (24) tension-resistantly connected at least to the shank end (3). The shank end (3) is provided with a punch edge (6) extending essentially along the outermost periphery of the shank end (3) and formed by a peripheral surface (26) and a face (25) of the shank end (3). In the center of the face (25), a projection is provided, protruding from the plane in which the punch edge (6) lies on the side away from the sethead (4). The projection may be formed by a conical or pyramidal surface.

The invention relates to a fastening element, in particular for blind riveting, having a hollow shank comprising a sethead at its free end, having a deformation segment to form a closure head, and having a connecting segment formed inside the shank, serving to form a tension-resistant connection with a mandrel, in particular the foot of a mandrel, the shank end opposed to the sethead being provided with a punch edge extending substantially along the outermost periphery of the shank and/or of the mandrel foot.

A fastening element of the kind mentioned above is described in DE 101 60 771 A1.

The object of the present invention is to improve a fastening element according to the prime patent with respect to its processing properties.

This object is accomplished, according to the invention, by a fastening element having the features of claim 1, by a fastening element having the features of claim 2 or a fastening element having the features of claim 5. Advantageous embodiments and refinements are the subject of the respective dependent claims.

The fastening element according to the invention includes a hollow shank having a sethead at its free end, a deformation segment to form a closure head, a connecting segment for tension-resistant connection to a mandrel arranged inside the shank, in particular the foot of a mandrel, the shank end comprising a punch edge extending essentially along the outermost periphery of the shank, formed by a peripheral surface and a face of the shank end, and having a projection in the center of the face, protruding from the plane in which the punch edge lies, on the side away from the sethead.

Alternatively, a fastening element according to the invention, in particular for blind riveting, is provided with a hollow shank comprising a sethead at its free end, with a deformation segment to form a closure head, with a mandrel inside the shank comprising a mandrel head and a mandrel foot, the foot being at least tension-resistantly connected to a shank end opposed to the sethead and comprising a punch edge extending essentially along the outermost periphery of the mandrel foot, and formed by a peripheral surface and a face of the mandrel foot, and a projection being provided in the center of the face, protruding from the plane in which the punch edge lies, on the side away from the sethead.

In this second alternative, the mandrel is a part of the fastening element, whereas in the first alternative, the mandrel may be both part of the fastening element and a part of the tool, in particular a setting device, and may be reused for additional setting operations.

In both alternatives for the fastening element, the conformation according to the invention leads to an improvement in the punching of rivet holes in a part. The projection arranged in the face somewhat deforms the part to be punched out before commencement of the punching operation, in the direction of the die serving as abutment. In this way, the pressure rise at impact of the fastening element on the work is cushioned, and the fastening element is stabilized against lateral yielding in its position relative to the work. The deformation of the work also affects the die side, and, when using a die comprising a plurality of segments movable transverse to the work, provides for an improved centering of the segments with respect to the punch edge of the fastening element. Upon the whole, the result is a better configuration of the surface of section at the work so that the surface of the shank of the fastening element then entering the punch opening is not damaged.

This is important so that the surface protection of the fastening element will not be impaired. Likewise, crack formation in the neighborhood of the punched hole is avoided, whereby the quality of the riveted connection is improved. The configuration of the punch edge according to the invention has the further advantage that the detached punch scraps will not adhere to the punch edge and so are easily disposed of.

The projection in the fastening element according to the invention is preferably of such size and shape that the detached punch scraps will come away automatically, and not be left adhering to the face. The projection may be set off from the face by a step, but the face may alternatively make a smooth transition from the punch edge to the projection. A conformation in which the face conforms to a conical or pyramidal surface tapering down in punch direction has proved highly advantageous, where the center of the face may be either flat or else pointed.

Especially good results have been obtained when the height of the projection, measured starting from the plane in which the punch edge lies, is 2.5% to 5% of the diameter or mean diameter of the punch edge. Further, it is advantageous if the face, at least in its region bordering on the punch edge, and the surrounding surface, form an included angle from 93° to 96° with each other. By such a configuration, with no appreciable effect on the height of the punch edge, the formation of a smooth surface of section with blunt cutting edge in the work is favored.

According to a further proposal of the invention, provision may be made so that the shank end or the mandrel foot of the fastening element, particularly in the region of the punch edge, is of greater strength, in particular hardened. Also by this measure, in the case of parts consisting of a stronger material, a satisfactory punch cut and a smooth surface of section are ensured. Deformations of the punch edge, which may impair the punching operation, are avoided.

The fastening element according to the invention is hollow inside, so that a mandrel may be passed through the sethead and the deformation segment in order to achieve an at least tension-resistant connection of mandrel foot and shank end. With the punch edge, while the fastening element is being pushed through a part, a hole is punched in the work. Here, of course, the punching force must be transmitted to the shank end by means of the mandrel, since the deformation segment cannot transmit this force. Owing to the configuration of the fastening element according to the invention, the punch forces acting on the work are kept small, and so smooth a surface of section is achieved in the work, with blunt cutting edge, that the surface of the shank entering the opening is not damaged.

Using a die to support the work during the punching operation, comprising a plurality of segments movable transverse to the work, it has also proved advantageous that the form of the face according to the invention serves to permit a better centering of the segment with respect to the punch edge prior to the cutting operation.

With the fastening element according to the invention, a riveted connection is achieved that resembles a blind rivet connection, because the closure head is formed by tensile stresses. Since the punching operation requires bilateral access to the work, however, this is not strictly speaking a blind riveting operation.

The deformation segment is deformed in that the shank end, with the aid of the mandrel introduced into the hollow shank, and with which a tension-resistant connection with the connecting segment is produced, is drawn in the direction of the sethead. By the deformation of the deformation segment, a closure head is formed. With the closure head, for example two parts may be connected to each other. The deformation segment is either made of softer material than the sethead or the shank end, or else rendered more readily deformable by suitable shaping, for example by thinner wall thicknesses and/or apertures and/or folds in the deformation segment.

By contrast with a punch rivet, a blind rivet will yield connections that are able to assume higher tensile and shearing stresses. Besides, the punch rivet process requires ductile material on the die side, which must moreover have a certain minimum thickness. This is disadvantageous in mixed construction. By virtue of the invention, this advantage is combined with the further advantage that no pre-drilled holes need be searched for into which the fastening element is to be inserted. Furthermore, any chips due to drilling the holes are avoided. The self-punching of the fastening element achieves an inner wall providing especially advantageous properties of the riveted connection with respect to maximum allowable tensions and shears.

With the aid of the mandrel, firstly, the force required to punch the hole for the fastening element can be transmitted to the work; in the second place, with the aid of the mandrel the shank end is drawn in the direction of the sethead. If part of the deformation segment protrudes in the rear of the work, it will be deformed by tension on the mandrel, i.e. in particular widened. If the deformation segment does not protrude in back, but is located inside the work, the deformation segment will be deformed in the interior of the work, and by its widening will effect a clamping, i.e. in particular a positive dynamic connection between fastening element and part.

Advantageous embodiments of the invention will be illustrated with reference to the drawing below. The drawing is to be understood as a special exemplary example of the invention, not to limit the scope of the invention. In the drawing,

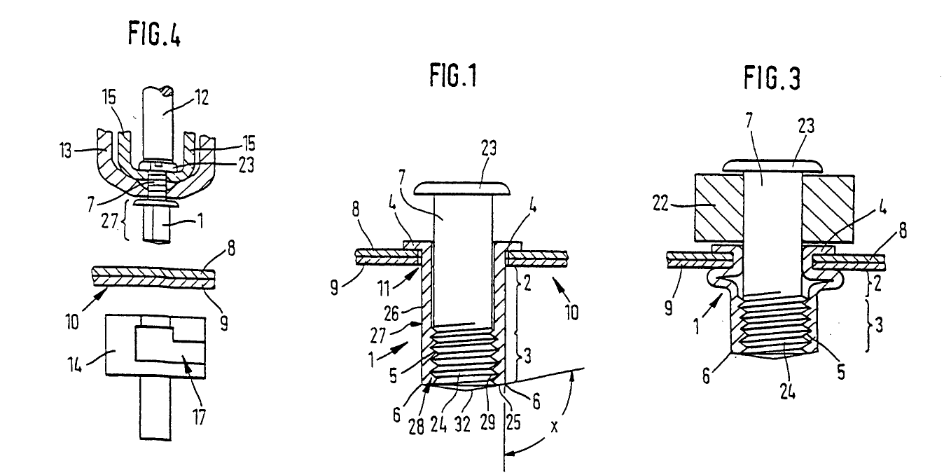

FIG. 1 shows a fastening element according to the invention, having a mandrel inserted in a part;

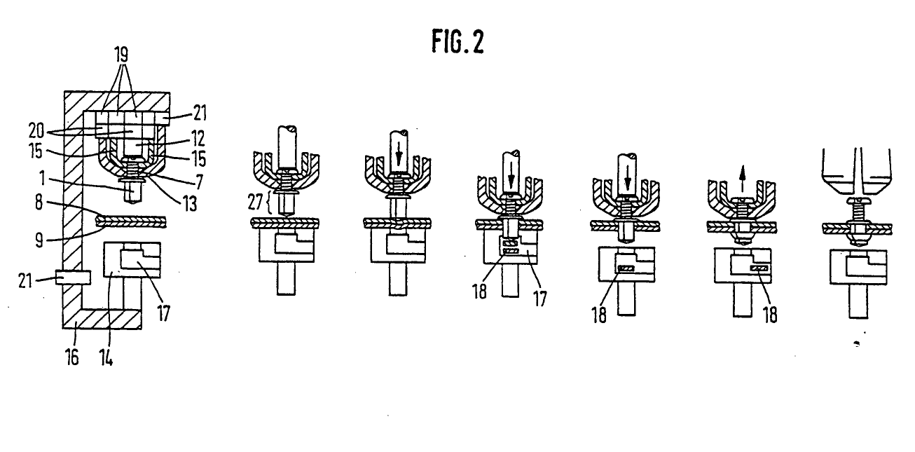

FIG. 2 shows a procedure according to the invention, in which the fastening element, containing a mandrel, is set by a device for setting a fastening element in a part;

FIG. 3 shows a riveted connection according to the invention, the additional part being attached to the work by means of a mandrel;

FIG. 4 shows a portion of a device according to the invention for setting a fastening element, together with a fastening element and a part just before the fastening element is set;

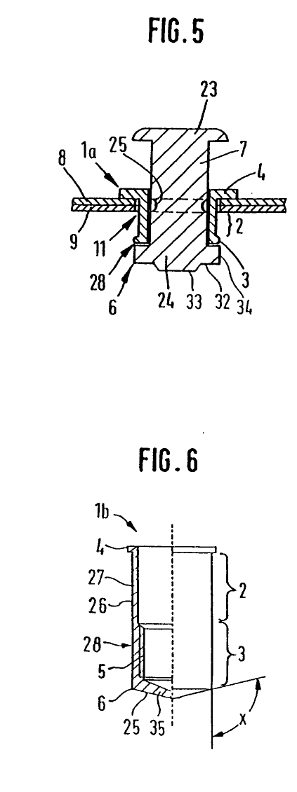

FIG. 5 shows a fastening element according to the invention with a mandrel having a foot on which the punch edge is configured;

FIG. 6 shows a fastening element according to the invention with a closed bottom.

FIG. 1 shows a fastening element 1 according to the invention, having a hollow shank 27 comprising a sethead 4, a deformation segment 2 and an end 3 with punch edge 6 and an internal thread 5, into which a mandrel 7 with head 23 and foot 24 is screwed. The tension-resistant connection between the mandrel 7 and the shank 27 is made by a connecting segment 28. The connecting segment 28 is formed by an internal thread 5 in the shank 27. The internal thread 5 is screwed into an external thread 29 on the mandrel 7. The fastening element 1 is punched through a first part 8 and a second part 9, the two parts 8, 9 having the conformation of sheets lying one upon the other. The fastening element 1 punches its own hole 11 through the parts 8, 9. The shank end 3 and a part of the deformable segment 2 are located in the back 10 of the second part 9. The deformation segment 2 has a smaller wall thickness than the shank end 3. The mandrel 7 comprises a head 23 with which, firstly, additional parts 22, as shown in FIG. 3, may be fastened, and on which the mandrel 7 can be drawn in the direction of the sethead 4. The sethead 4 rests firmly on the first part 8.

The shank 27 has a cylindrical peripheral surface 26 and, at its end 3, an annular face 25, which together form the punch edge 6. In the center of the face 25, there is a face 32 configured on the foot 24 of the mandrel. The two faces 25, 32 pass smoothly into each other and together form a flat conical surface, whose outward projecting point lies on the centerline of the mandrel 7. In this way, the face 32 forms, in particular with its tip, a projection protruding from the plane in which the punch edge 6 lies on the side of the fastening element 1 away from the sethead, and in the punching operation, strikes the work before the punch edge 6 reaches the work. The inclination of the conical surface formed by the faces 25, 32 is so dimensioned that the face 25 makes an included angle X of 93° to 96° with the peripheral surface 26.

FIG. 2 describes a procedure of setting a fastening element 1 according to the invention. Into the fastening element 1, held by a holding tool 13, a mandrel 7 is screwed. With the aid of moving means 19, the fastening element 1 is set on a first part 8, to be connected to a second part 9. The position of the fastening element 1 relative to the parts 8, 9 is acquired with the aid of position-determining means 19. The parts 8, 9 are first placed on a die 14 comprising a disposal passage 17 for parts 18 punched out. Then the fastening element 1 is so set on the first part 8 with the aid of the holding tool 13 that the shank end 3 of the fastening element 1 makes contact with the first part 8 at the point of the face 32. With the aid of a stamp 12, a force is then exerted against the parts 8, 9 on the mandrel 7, and the shank end 3 is pushed through the parts 8, 9. In this operation, first the parts 8, 9 are deformed in the region of the projecting face 32, and then severed by means of the punch edge 6.

During the motion of the stamp 12, both the holding tool 13 and a tension tool 15 are carried along. Punched out parts 18 drop into the disposal passage 17 where they are then disposed of, preferably with the aid of a positive or negative air pressure line. Then the die 14 is removed from the parts 8, 9, so that the shank end, or the projecting deformation segment, is free. The removal of the die may be omitted if this is made yielding in radial direction, as shown in the prime patent. Then the tension tool 15 pulls on the mandrel 7, while the holding tool 13 presses the sethead against the first part 8. The tension deforms the deformation segment 2, whereas the shank end 3 is not plastically deformed. With the aid of stress sensors 21, the drawing and the punching are monitored and the data detected by the stress sensors 21 control the motion of the tension and/or the holding tool. Finally, the mandrel 7 may be screwed out of the fastening element 1 or used to fasten an additional part.

FIG. 3 shows a riveted connection produced in the manner described, the fastening element 1 being deformed in its deformation segment 2. By means of the mandrel 7 and its head 23, an additional part 22, which may be a suspension, is attached to the parts 8, 9. The parts 8, 9 are firmly clamped between the sethead 4 and the deformation segment 2.

FIG. 4 shows a detail view of the device for setting the fastening element 1. The fastening element 1 is held with the aid of the holding tool 13 on the mandrel 7 screwed into the fastening element 1. The tension tool 15 grasps the mandrel 7 by its head 23. The stamp 12 presses on the head 23 of the mandrel 7. The parts 8, 9 are arranged between the fastening element 1 and the die 14, the die 14 assuming, from the back 10 of the second part 9, the force exerted by the stamp 12 on the parts 8, 9 by way of the mandrel 7.

FIG. 5 shows an alternative fastening element 1a having a mandrel 7 punched into two parts 8, 9. The hole 11 was punched in the parts 8, 9 with the punch edge 6 configured on the foot 24 of the mandrel. The punch edge 6 is formed by a cylindrical peripheral surface 34 and a plane face 32 of the foot 24 of the mandrel, and has a sharp, essentially rectangular shape. In the center of the face 32, a projection 33 set off by a step is provided, deforming the part prior to cutting. By means of the head 23, the mandrel 7 can be drawn back so that first the deformation segment 2 is deformed and then the mandrel head 23 parts from the foot 24 at a weak point 25. The tension-resistant connection between mandrel 7 and shank [2]7 is made by the connecting segment 28.

FIG. 6 shows a fastening element 1b having a hollow cylindrical shank 27 whose bore is closed by a bottom 35 at the shank end 3 opposed to the sethead 4. The shank end 3 forms a connecting segment 28 provided with an internal thread 5. The internal thread 5 serves for screwing in a tool mandrel that transmits the punch force for penetrating a part and the setting force for deforming the deformation portion 2 to the fastening element 1b. After the setting, the tool mandrel is removed and a screw is screwed into the internal thread 5 to fasten a part. The bottom 35 of the fastening element 1b is provided on the outside with a conical face 25, forming an obtuse-angled punch edge 6 together with the cylindrical periphery 26. The angle of the punch edge 6 is designated by X and is preferably 93° to 96°.

| | |
|---|---|
| 1 | fastening element |
| 1a | fastening element |
| 1b | fastening element |
| 2 | deformation segment |
| 3 | shank end |
| 4 | sethead |
| 5 | internal thread |
| 6 | punch edge |
| 7 | mandrel |
| 8 | first part |
| 9 | second part |
| 10 | back |
| 11 | punch hole |
| 12 | stamp |
| 13 | holding tool |
| 14 | die |
| 15 | tension tool |
| 16 | abutment |
| 17 | disposal passage |
| 18 | punched out part |
| 19 | moving means |
| 20 | position-determining means |
| 21 | stress sensor |
| 22 | additional part |
| 23 | mandrel head |
| 24 | mandrel foot |
| 25 | face |
| 26 | periphery |
| 27 | shank |
| 28 | connecting segment |
| 29 | external thread |
| 30 | closure head |
| 31 | mandrel core |
| 32 | face |
| 33 | projection |
| 34 | periphery |
| 35 | bottom |
| X | angle |

1. Fastening element (1), in particular for blind riveting, having a hollow shank (27) comprising a sethead (4) at its free end, having a deformation segment (2) to form a closure head, and having a connecting segment (28) formed inside the shank (27) and serving to form a tension-resistant connection to a mandrel (7), in particular the foot (24) of a mandrel (7), the shank end (3) opposed to the sethead (4) being provided with a punch edge (6) extending essentially along the outermost periphery of the shank (27) and formed by a peripheral surface (26) and a face (25) of the shank end (3), and a projection being provided in the center of the face (25) protruding from the plane in which the punch edge (6) lies on the side away from the sethead (4).

2. Fastening element (1), in particular for blind riveting, having a hollow shank (27) comprising a sethead (4) at its free end, having a deformation segment (2) to form a closure head, having a mandrel (7) inside the shank (27), comprising a mandrel head (23) and a mandrel foot (24), the mandrel foot (24) being at least tension-resistantly connected to a shank end (3) opposed to the sethead (4), the shank end (3) comprising a punch edge (6) extending essentially along the outermost periphery of the shank (27) and formed by a peripheral surface (26) and a face (25) of the shank end (3), and a projection being provided in the center of the face (25), protruding from the plane in which the punch edge (6) lies on the side away from the sethead (4).

3. Fastening element according to claim 1, characterized in that the shank end (3) opposed to the sethead (4) is open and the projection is arranged at the foot (24) of the mandrel.

4. Fastening element according to claim 1, characterized in that the shank end (3) opposed to the sethead (4) is closed and forms the projection with a bottom (35).

5. Fastening element according to claim 1, characterized in that, inside the shank (27), a connecting segment (28) is formed, serving to form a tension-resistant connection with the mandrel (7), in particular the foot (24) of the mandrel (7).

6. Fastening element (1), in particular for blind riveting, having a hollow shank (27) comprising a sethead (4) at its free end, having a deformation segment (2) to form a closure head, having a mandrel (7) inside the shank (27) comprising a mandrel head (23) and a mandrel foot (24), the mandrel foot (24) being tension-resistantly connected at least to a shank end (3) opposed to the sethead (4) and comprising a punch edge (6) extending essentially along the outermost periphery of the mandrel foot (24), and formed by a peripheral surface (34) and a face (32) of the mandrel foot (24), and a projection (33) being provided in the center of the face (32), protruding from the plane in which the punch edge (6) lies on the side away from the sethead (4).

7. Fastening element (1) according to claim 1, characterized in that the projection (33) is offset from the face by a step.

8. Fastening element (1) according to claim 1, characterized in that the face (25) passes smoothly from the punch edge (6) into the projection.

9. Fastening element (1) according to claim 1, characterized in that the height of the projection measured from the plane in which the punch edge lies is 2.5% to 5% of the diameter, or mean diameter, of the punch edge.

10. Fastening element (1) according to claim 1, characterized in that the face (25, 32) has a shape conforming to a conical or pyramidal surface tapering down in the punching direction.

11. Fastening element (1) according to claim 1, characterized in that the cross-section of the fastening element (1) is substantially circular.

12. Fastening element (1) according to claim 1, characterized in that the face (25) and the peripheral surface (26) make an included angle of 93° to 96° with each other.

13. Fastening element (1) according to claim 1, characterized in that the cross-section of the fastening element (1) is substantially polygonal.

14. Fastening element (1) according to claim 1, characterized in that the mandrel head (23) is widened.

15. Fastening element (1) according to claim 1, characterized in that the shank end (3) or the mandrel foot (24), at least in the region of the punch edge (6), is stronger, in particular hardened.

16. Fastening element according to claim 2, characterized in that the shank end (3) opposed to the sethead (4) is open and the projection is arranged at the foot (24) of the mandrel.

17. Fastening element according to claim 2, characterized in that the shank end (3) opposed to the sethead (4) is closed and forms the projection with a bottom (35).

18. Fastening element according to claim 2, characterized in that, inside the shank (27), a connecting segment (28) is formed, serving to form a tension-resistant connection with the mandrel (7), in particular the foot (24) of the mandrel (7).

19. Fastening element (1) according to claim 2, characterized in that the projection (33) is offset from the face by a step.

20. Fastening element (1) according to claim 2, characterized in that the face (25) passes smoothly from the punch edge (6) into the projection.

21. Fastening element (1) according to claim 2, characterized in that the height of the projection measured from the plane in which the punch edge lies is 2.5% to 5% of the diameter, or mean diameter, of the punch edge.

22. Fastening element (1) according to claim 2, characterized in that the face (25, 32) has a shape conforming to a conical or pyramidal surface tapering down in the punching direction.

23. Fastening element (1) according to claim 2, characterized in that the cross-section of the fastening element (1) is substantially circular.

24. Fastening element (1) according to claim 2, characterized in that the face (25) and the peripheral surface (26) make an included angle of 93° to 96° with each other.

25. Fastening element (1) according to claim 2, characterized in that the cross-section of the fastening element (1) is substantially polygonal.

26. Fastening element (1) according to claim 2, characterized in that the mandrel head (23) is widened.

27. Fastening element (1) according to claim 2, characterized in that the shank end (3) or the mandrel foot (24), at least in the region of the punch edge (6), is stronger, in particular hardened.

28. Fastening element (1) according to claim 6, characterized in that the projection (33) is offset from the face by a step.

29. Fastening element (1) according to claim 6, characterized in that the face (25) passes smoothly from the punch edge (6) into the projection.

30. Fastening element (1) according to claim 6, characterized in that the height of the projection measured from the plane in which the punch edge lies is 2.5% to 5% of the diameter, or mean diameter, of the punch edge.

31. Fastening element (1) according to claim 6, characterized in that the face (25, 32) has a shape conforming to a conical or pyramidal surface tapering down in the punching direction.

32. Fastening element (1) according to claim 6, characterized in that the cross-section of the fastening element (1) is substantially circular.

33. Fastening element (1) according to claim 6, characterized in that the face (25) and the peripheral surface (26) make an included angle of 93° to 96° with each other.

34. Fastening element (1) according to claim 6, characterized in that the cross-section of the fastening element (1) is substantially polygonal.

35. Fastening element (1) according to claim 6, characterized in that the mandrel head (23) is widened.

36. Fastening element (1) according to claim 6, characterized in that the shank end (3) or the mandrel foot (24), at least in the region of the punch edge (6), is stronger, in particular hardened.
